(19) United States
(12) Patent Application Publication
(10) Pub. No.: US 2005/0257127 A1
(43) Pub. Date: Nov. 17, 2005

(54) Document production assist apparatus, document production assist program and storage medium, and document production assist method

(75) Inventors: Toshio Tanaka, Shiojiri-shi (JP); Atsushi Nagahara, Chino-shi (JP)

Correspondence Address: OLIFF & BERRIDGE, PLC, P.O. BOX 19928, ALEXANDRIA, VA, 22320, US

(73) Assignee: SEIKO EPSON CORPORATION, Tokyo (JP)

(21) Appl. No.: 11/130,074

(22) Filed: May 17, 2005

(30) Foreign Application Priority Data
May 17, 2004 (JP) 2004-146435
Feb. 10, 2005 (JP) 2005-034268

(51) Int. Cl. G06F 17/00

(52) U.S. Cl. 715/500; 705/14

(57) ABSTRACT

Aspects of the invention can provide a document production assist apparatus that can include a concept input section that inputs a target concept for deciding insert information and a template that are to be included in document data, the insert information being to define a content of the document data and the template being to define a form of the document data, an insert information storage section that stores a plurality of pieces of insert information having concepts, a template storage section that can store a plurality of template having concepts, an insert information search section that searches for candidates of insert information corresponding to the target concept inputted at the concept input section, through the insert information storage section, an insert information selecting section that can select insert information intended to be included in the document data, out of the candidates of insert information, a concept correcting section that corrects the target concept inputted at the concept input section, depending upon the concept of insert information selected, a template search section that can search for candidates of template corresponding to the target concept corrected through the template storage section, a template selecting section that selects a template intended to be included in the document data, out of the candidates of template, and a document data producer section that can produce the document data from the selected insert information and the selected template.

### BACKGROUND

Aspects of the invention can relate to a document production assist apparatus, document production assist program and storage medium, and document production assist method.

Related art work production assist systems, such as that described in JP-A-8-212258, and a document-design deciding apparatus, such as that described in JP-A-6-12408, are known. The work production assist system in the former can search an output attribute (combination of a background pattern, a layout and a color, etc.) depending upon feature information (a work kind, subject of person, atmosphere, etc.) inputted by the user, to thereby produce a work by use of the attribute outputted. Meanwhile, the document-design deciding apparatus in the latter can make a predetermined operation on the finished image information (sophistication, reliability, space, etc.), thus deciding a document design in accordance with the result of the operation.

However, in these related art systems and apparatus, the feature information and the image information are of fixed nature not allowed for corrections nor changes. Thus, there is a problem of incapability of producing or deciding a work or a document design that exact nuances are suitably reflected to a user's desire as to the feature information and image information. Meanwhile, the former system could not use, commonly, the feature information inputted for searching a background pattern and the feature information inputted for searching a layout. Therefore, there is a problem of incapability of reflecting the user's expected nuance commonly upon both the searched background pattern and the searched layout.

### SUMMARY

According to an aspect of the invention, a document production assist apparatus can include a concept input section that inputs a target concept for deciding insert information and a template that are to be included in document data, the insert information being to define a content of a document data and the template being to define a form of the document data, an insert information storage section that stores a plurality of pieces of insert information having concepts, a template storage section that stores a plurality of template having concepts, an insert information search section that can search for candidates of insert information corresponding to the target concept inputted at the concept input section, through the insert information storage section, an insert information selecting section that selects insert information intended to be included in the document data, out of the candidates of insert information, a concept correcting section that corrects the target concept inputted at the concept input section, depending upon the concept of insert information selected, a template search section that searches for candidates of template corresponding to the target concept corrected through the template storage section, a template selecting section that can select a template intended to be included in the document data, out of the candidates of template, and a document data producer section that can produce the document data from the selected insert information and the selected template.

With this arrangement, the concept correcting section corrects the target concept inputted at the concept input section according to the selected concept of insert information, thus making it possible to reflect appropriately the precise nuance the user desires. In addition, because the template search section and template selecting section are allowed to search and select template candidates corresponding to the corrected target concept, the target concept can be reflected commonly in selecting the insert information and in selecting the template.

Here, the apparatus may be realized as a single terminal or other apparatuses, or as a network system connected for communication with a plurality of terminals or other apparatuses. In the latter case, the constituent elements, when connected communicatably, may belong to any of the plurality of apparatuses. This is true for the document production assist apparatus described below.

In accordance with an aspect of the invention, the document production assist apparatus described above can further include a user information storage section that stores information about a plurality of users, a user search section that searches for candidates of user corresponding to the target concept, through the user information storage section, and a user selecting section that selects a user who intends to utilize the document data, out of the candidates of user, wherein the concept correcting section corrects the target concept depending upon the selected information about user.

In a document production assist apparatus according to the invention, the document data producer section can add the document data with output information for outputting the document data meeting the target concept.

Here, the addition of the document data with output information includes embedding output information in the document data and associating output information with the document data. The latter case is to be implemented by use of a table or other databases, for example. Namely, it may be any form, provided that the correspondence between the document data and the output information can be grasped directly or indirectly. This is true for the document production assist apparatus described below.

According to another aspect of the invention, a document production assist apparatus can include a concept input section that inputs a target concept for deciding first information defining one of content and form of document data and second information defining the one or the other, that are to be included in the document data, a first information storage section that stores a plurality of pieces of first information having concepts, a second information storage section that stores a plurality of pieces of second information having concepts, a first search section that stores for candidates of first information corresponding to the target concept inputted at the concept input section, through the first information storage section, a first information selecting section that selects first information intended to be included in the document data, from the candidate of first information, a concept correcting section that corrects the target concept inputted at the concept input section, depending upon the selected concept of first information, a second information search section that searches for candidates of second information corresponding to the corrected target concept, through the second information storage section, a second information selecting section that selects second information intended to be included in the document data, out of the candidates of second information, and a document data producer section that produces the document data from the first information selected and the second information selected.

According to an aspect of the invention, a document production assist program can cause a computer, having a concept input section, an insert information search section, an insert information selecting section, a concept correcting section, a template search section, a template selecting section and a document data producer section that are to cooperatively assist in producing document data, to assist in producing the document data having insert information defining a content of document data and the template defining a form of the document data. The program can include an input step of causing the concept input section to input a target concept for deciding the insert information and the template, a first search step of causing the insert information search section to search for candidates of insert information corresponding to the target concept, a first selecting step of causing the insert information selecting section to select insert information intended to be included in the document data, out of the candidates of insert information, a correcting step of causing the concept correcting section to correct the target concept depending upon the selected concept of insert information, a second search step of causing the template search section to search for candidates of template corresponding to the corrected target concept, a second selecting step of causing the template selecting section to select a template intended to be included in the document data out of the candidates of template, and a producing step of causing the document data producer section to produce the document data from the selected insert information and the selected template.

According to an aspect of the invention, a document production assist method can include a concept input step of inputting a target concept for deciding the insert information and a template that are to be included in document data, the insert information being to define a content of document data and the template being to define a form of the document data, an insert information search step of searching for candidates of insert information corresponding to the target concept, an insert information selecting step of selecting insert information intended to be included in the document data, out of the candidates of insert information, a concept correcting step of correcting the target concept inputted in the input step, depending upon the selected concept of insert information, a template search step of searching for candidates of template corresponding to the corrected target concept, a template selecting step of selecting a template intended to be included in the document data, out of the candidates of templates, and a document data producing step of producing the document data from the selected insert information and the selected template.

According to another aspect of the invention, a document production assist apparatus can include a concept input section that allows to input a target concept for extracting insert information and a template, an insert information storage section that stores the insert information including concepts, a template storage section that stores the template including concepts, an insert information search section that searches out candidates of insert information corresponding to the target concept inputted at the concept input section, from the insert information storage section, an insert information selecting section that selects insert information intended to be included in document data, out of the extracted candidates of insert information, a concept correcting section that corrects the target concept inputted at the concept input section, depending upon the selected concept of insert information, a template search section that searches out candidates of template corresponding to the corrected target concept, from the template storage section, a template selecting section that selects a template intended to be included in the document data, out of the extracted candidates of template, and a document data producer section that produces the document data from the selected insert information and the selected template.

With this arrangement, when a target concept is inputted through the concept input section, the insert information search section can search out the candidates of insert information corresponding to the inputted target concept, from the insert information storage section. Then, when the insert information selecting section selects insert information out of the extracted candidates of insert information, the concept correcting section corrects the inputted target concept depending upon the selected concept of insert information. The template search section searches out candidates of template corresponding to the corrected target concept, from the template storage section. When the template selecting section selects a template out of the extracted candidates of template, the document data producer section produces the document data from the selected insert information and the selected template. This can provide an effect that the target concept can be reflected commonly in selecting insert information and in selecting a template.

Another aspect of the invention, according to the document production assist apparatus described above, can further include a user information storage section that stores information about user, a user search section that searches out candidates of users corresponding to the target concept from the user information storage section, and a user selecting section that selects a user who intends to utilize the document data, out of the candidates of user. The concept correcting section corrects the target concept depending upon the selected information about user. With this arrangement, the user search section can search out the candidates of users corresponding to the target concept, from the user information storage section. When the user selecting section selects a user out of the user candidates, the concept correcting section corrects the target concept in accordance with the selected information about user.

In an exemplary document production assist apparatus, the document data producer section can add the document data with output information corresponding to the target concept. With this arrangement, the document data producer section can add the output information corresponding to the target concept, to the document data.

An exemplary document production assist apparatus can include a concept input section that allows to input a target concept for extracting first information as one of insert information and a template and second information as the other of the insert information and the template, a first information storage section that stores the first information including concepts, a second information storage section that stores the second information including concepts, a first information search section that searches out candidates of first information corresponding to the target concept inputted at the concept input section, from the first information storage section, a first information selecting section that selects first information intended to be included in document data, out of the extracted candidates of first information, a concept correcting section that corrects the target concept inputted at the concept input section, depending upon the selected concept of first information, a second information search section that searches out candidates of second information corresponding to the corrected target concept, from the second information storage section, a second information selecting section that selects second information intended to be included in the document data, out of the extracted candidates of second information, and a document data producer section that produces the document data from the selected first information and the selected second information.

With this arrangement, when the target concept is inputted at the concept input section, the first information search section searches out the candidates of first information corresponding to the inputted target concept, from the first information storage section. Then, the first information selecting section can select first information out of the extracted first information candidates, the concept correcting section corrects the inputted target concept depending upon the selected first information concept. The second information search section can search out the candidates of second information corresponding to the corrected target concept, from the second information storage section. When the second information selecting section selects the second information out of the extracted second information candidates, the document data producer section produces document data from the selected first information and second information. This can provide an effect that the target concept can be reflected commonly in selecting first information and in selecting second information.

A document production assist program can include a program that causes a computer to execute a process including: a concept input step of inputting a target concept for extracting insert information and a template, an insert information search step of searching out candidates of insert information corresponding to the target concept inputted in the concept input step, from the insert information storage section storing the insert information including concepts, an insert information selecting step of selecting insert information intended to be included in document data, out of the extracted candidates of insert information, a concept correcting step of correcting the target concept inputted at the concept input section, depending upon the selected concept of insert information, a template search step of searching out candidates of template corresponding to the corrected target concept, from the template storage section storing the template including concepts, a template selecting step of selecting a template intended to be included in the document data, out of the extracted candidates of template, and a document data producing step of producing the document data from the selected insert information and the selected template. With this arrangement, reading out the program the computer can be caused to execute the process according to the program, and therefore operation and effect can be obtained similarly to the document production assist program described above.

A document production assist program of the invention, according to the document production assist program described above, can further include a program that causes a computer to execute a process including a user search step of searching out candidates of users corresponding to the target concept from the user information storage section that stores information about users, and a user selecting step of selecting a user who intends to utilize the document data, out of the candidates of user, wherein the concept correcting step corrects the target concept depending upon the selected information about user. With this arrangement, reading out the program, the computer can be caused to execute the process according to the program, and therefore operation and effect can be obtained similarly to the document production assist program described above.

In an exemplary document production assist program of the invention, according to the document production assist program, the document data producing step adds the document data with output information corresponding to the target concept. With this arrangement, reading out the program, the computer is caused to execute the process according to the program, and therefore operation and effect are obtained similarly to the document production assist program described above.

According to the invention, a document production assist program can include a program that causes a computer to execute a process including a concept input step of inputting a target concept for extracting first information as one of insert information and a template and second information as the other of the insert information and the template, a first information search step of searching out candidates of first information corresponding to the target concept inputted in the concept input step, from a first information storage section storing the first information including concepts, a first information selecting step of selecting first information intended to be included in document data, out of the extracted candidates of first information, a concept correcting step of correcting the target concept inputted in the concept input step, depending upon the selected concept of first information, a second information search step of searching out candidates of second information corresponding to the corrected target concept, from second information storage section storing the second information including concepts, a second information selecting step of selecting second information intended to be included in the document data, out of the extracted candidates of second information, and a document data producing step of producing the document data from the selected first information and the selected second information. With this arrangement, reading out the program, the computer can be caused to execute the process according to the program, and therefore operation and effect are obtained similarly to the document production assist program described above.

According to an exemplary document production assist program, a computer-readable storage medium records a program that causes a computer to execute a process including a concept input step of inputting a target concept for extracting insert information and a template, an insert information search step of searching out candidates of insert information corresponding to the target concept inputted in the concept input step, from the insert information storage section storing the insert information including concepts, an insert information selecting step of selecting insert information intended to be included in document data, out of the extracted candidates of insert information, a concept correcting step of correcting the target concept inputted at the concept input section, depending upon the selected concept of insert information, a template search step of searching out candidates of template corresponding to the corrected target concept, from the template storage section storing the template including concepts, a template selecting step of selecting a template intended to be included in the document data, out of the extracted candidates of template, and a document data producing step of producing the document data from the selected insert information and the selected template.

With this arrangement, reading the program out of the storage medium, the computer is caused to execute the process according to the program, operation and effect is obtained similarly to the document production assist apparatus described above.

A storage medium of the invention, according to the storage medium described above, can further record a program that causes a computer to execute a process including a user search step of searching out candidates of users corresponding to the target concept from the user information storage section that stores information about users, and a user selecting step of selecting a user who intends to utilize the document data, out of the candidates of user. The concept correcting step corrects the target concept depending upon the selected information about user. With this arrangement, reading the program out of the storage medium, the computer is caused to execute the process according to the program, operation and effect is obtained similarly to the document production assist apparatus described above.

In accordance with a storage medium of the invention, in the storage medium described above, the document data producing step is to add the document data with output information corresponding to the target concept. With this arrangement, reading the program out of the storage medium, the computer is caused to execute the process according to the program, operation and effect is obtained similarly to the document production assist apparatus described above.

According to a storage medium of the invention, a computer-readable storage medium stores a program that causes a computer to execute a process including a concept input step of inputting a target concept for extracting first information as one of insert information and a template and second information as the other of the insert information and the template, a first information search step of searching out candidates of first information corresponding to the target concept inputted in the concept input step, from a first information storage section storing the first information including concepts, a first information selecting step of selecting first information intended to be included in document data, out of the extracted candidates of first information, a concept correcting step of correcting the target concept inputted in the concept input step, depending upon the selected concept of first information, a second information search step of searching out candidates of second information corresponding to the corrected target concept, from a second information storage section storing the second information including concepts, a second information selecting step of selecting second information intended to be included in the document data, out of the extracted candidates of second information, and a document data producing step of producing the document data from the selected first information and the selected second information. With this arrangement, reading the program out of the storage medium the computer is caused to execute the process according to the program, operation and effect is obtained similarly to the document production assist apparatus described above.

According to a document production assist method of the invention, a document production assist method can include a concept input step of inputting a target concept for extracting insert information and a template, an insert information search step of searching out candidates of insert information corresponding to the target concept inputted in the concept input step, from the insert information storage section storing the insert information including concepts, an insert information selecting step of selecting insert information intended to be included in document data, out of the extracted candidates of insert information, a concept correcting step of correcting the target concept inputted in the concept input step, depending upon the selected concept of insert information, a template search step of searching out candidates of template corresponding to the corrected target concept, from the template storage section storing the template including concepts, a template selecting step of selecting a template intended to be included in the document data, out of the extracted candidates of template, and a document data producing step of producing the document data from the selected insert information and the selected template. This can provide an effect similar to that of the document production assist apparatus described above.

According to another exemplary aspect of the invention, a document production assist method can include a concept input step that an input section inputs a target concept for extracting insert information and a template, an insert information search step that a search section searches out candidates of insert information corresponding to the target concept inputted in the concept input step, from the insert information storage section storing the insert information including concepts, an insert information selecting step that a selecting section selects insert information intended to be included in document data, out of the extracted candidates of insert information, a concept correcting step that a processor section corrects the target concept inputted at the concept input section, depending upon the selected concept of insert information, a template search step that the search section searches out candidates of template corresponding to the corrected target concept, from the template storage section storing the template including concepts, a template selecting step that the selecting section selects a template intended to be included in the document data, out of the extracted candidates of template, and a document data producing step that a producer section produces the document data from the selected insert information and the selected template. This can provide an effect similar to that of the document production assist apparatus as described above.

An exemplary document production assist method of the invention, according to the document production assist method described above, can further include a user search step of searching candidate of users corresponding to the target concept, out of the user information storage section storing information about user, and a user selecting step of selecting a user who is to use the document data, wherein the concept correcting step is to correct the target concept in accordance with the selected information about user.

In an exemplary document production assist method of the invention, according to the document production assist method described above, the document data producing step is to add the document data with output information corresponding to the target concept.

According to the invention, a document production assist method can include a concept input step that inputs a target concept for extracting first information as one of insert information and a template and second information as the other of the insert information and the template, a first information search step that searches out candidates of first information corresponding to the target concept inputted in the concept input step, from a first information storage section storing the first information including concepts, a first information selecting step that selects first information intended to be included in document data, out of the extracted candidates of first information, a concept correcting step that corrects the target concept inputted in the concept input step, depending upon the selected concept of first information, a second information search step that searches out candidates of second information corresponding to the corrected target concept, from second information storage section storing the second information including concepts, a second information selecting step that selects second information intended to be included in the document data, out of the extracted candidates of second information, and a document data producing step that produces the document data from the selected first information and the selected second information.

This provides an effect similar to that of the document production assist apparatus described above.

According to the invention, a document production assist method can include a concept input step that an input section inputs a target concept for extracting first information as one of insert information and a template and second information as the other of the insert information and the template, a first information search step that a search section searches out candidates of first information corresponding to the target concept inputted in the concept input step, from a first information storage section storing the first information including concepts, a first information selecting step that a selecting section selects first information intended to be included in document data, out of the extracted candidates of first information, a concept correcting step that a processor section corrects the target concept inputted in the concept input step, depending upon the selected concept of first information, a second information search step that the search section searches out candidates of second information corresponding to the corrected target concept, from second information storage section storing the second information including concepts, a second information selecting step that the selecting section selects second information intended to be included in the document data, out of the extracted candidates of second information, and a document data producing step that a producer section produces the document data from the selected first information and the selected second information. This can provide an effect similar to that of the document production assist apparatus as described above.

### BRIEF DESCRIPTION OF THE DRAWINGS

The invention will be described with reference to the accompanying drawings, wherein like numbers reference like elements, and wherein:

FIG. 1 is an exemplary block diagram showing an arrangement of a document production assist apparatus according to an exemplary embodiment;

FIGS. 2A and 2B are figures showing insert information in the embodiment;

FIGS. 3A and 3B are figures showing a template in the embodiment;

FIGS. 4A and 4B are figures showing customer information in the embodiment;

FIG. 5 is a flowchart showing an exemplary operation of the document production assist apparatus in the embodiment (1/2);

FIG. 6 is a flowchart showing an exemplary operation of the document production assist apparatus in the embodiment (2/2);

FIG. 7 is a figure showing a display section in the embodiment (1/4);

FIG. 8 is a figure showing a display section in the embodiment (2/4);

FIG. 9 is a figure showing a display section in the embodiment (3/4);

FIG. 10 is a figure showing a display section in the embodiment (4/4);

FIG. 11 is a figure showing a production of document data by means of a producer section in the exemplary embodiment (1/3);

FIG. 12 is a figure showing a production of document data by means of the producer section in the exemplary embodiment (2/3);

FIG. 13 is a figure showing a production of document data by means of the producer section in the exemplary embodiment (3/3);

FIG. 14 is a figure showing an adjustment of document data by means of the producer section in the exemplary embodiment;

FIG. 15 is a figure showing an addition of output information by means of the producer section in the exemplary embodiment;

FIG. 16 is a figure showing a correction of a target concept by means of the processor section in the exemplary embodiment;

FIG. 17 is an exemplary block diagram showing an arrangement of a network system on which the major function is provided on a server;

FIG. 18 is a block diagram showing an arrangement of a network system on which the major function is provided on a host terminal;

FIG. 19 is a block diagram showing an arrangement of a network system on which the function is provided separately on the host terminal and the server nearly equally;

FIG. 20 is a flowchart showing a target concept correction process for correcting a target concept TCO depending upon customer information CL;

FIG. 21 is an on-two-dimensional-space representation of the concepts CO of customer information CL shown in FIG. 4B, correspondingly to FIG. 8;

FIG. 22 is an on-two-dimensional-space representation of the concepts CO of customer information CL shown in FIG. 4B, correspondingly to FIG. 8;

FIG. 23 is an additional display, to FIG. 9, of the concepts CO of insert information IN shown in FIG. 2B;

FIG. 24 is an additional display, to FIG. 10, of the concepts CO of templates TE shown in FIG. 3B;

FIG. 25 is an additional display, to FIG. 10, of the concepts CO of templates TE shown in FIG. 3B; and

FIG. 26 is a figure showing a storage medium and its data structure.

### DETAILED DESCRIPTION OF PREFERRED EMBODIMENTS

With reference to the drawings, description will be now made on a document production assist apparatus by way of exemplary embodiments according to the invention.

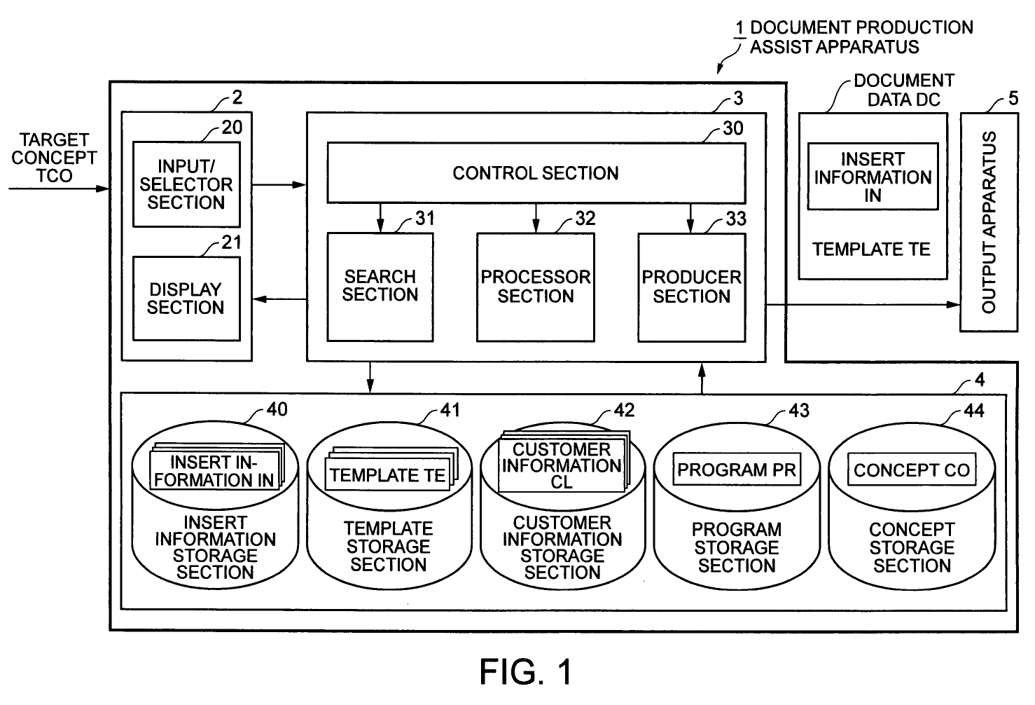

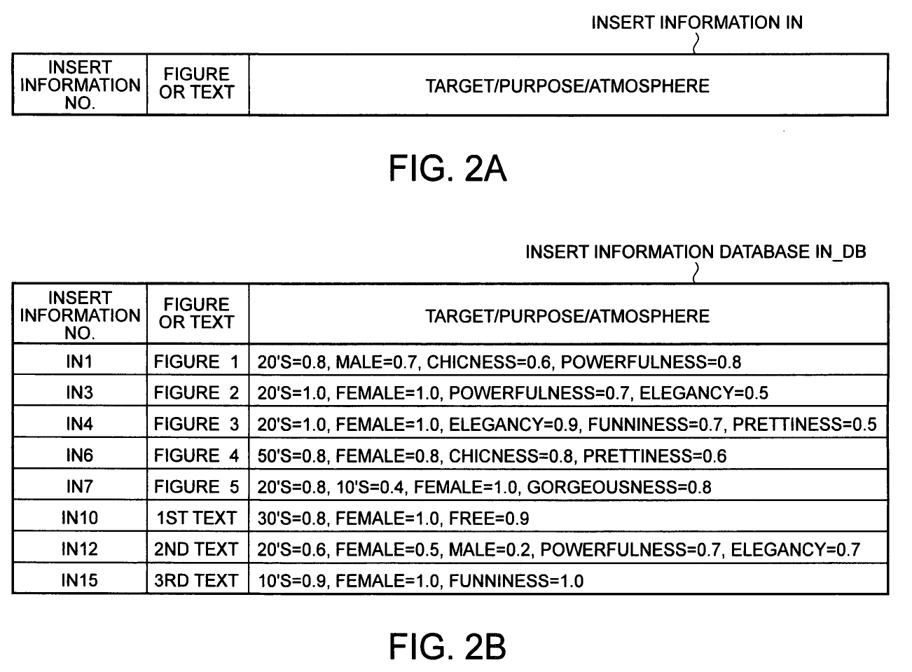

FIG. 1 is a block diagram showing an arrangement of a document production assist apparatus according to the exemplary embodiment. A document production assist apparatus 1 in this embodiment is connected to an output apparatus 5 (e.g., an inkjet printer or a projector) for printing or displaying a document depending upon document data. This is arranged with a information exchange unit 2, a processing unit 3 and a storage unit 3, in order for assisting the user on the document production assist apparatus 1, i.e., a designer, to prepare document data DC including insert information IN and template TE to meet a concept CO the designer desires (hereinafter, referred to as “target concept TCO”) (design concept, notion, idea, course of action or the like intended by the designer). Specifically, the concept CO is based on a target customer (hereinafter, referred to as “target”), a purpose of document production (hereinafter, referred to as “purpose”) and an atmosphere of entire document (hereinafter, referred to as “atmosphere”).

Here, “document data” is a general term on text data and drawing data, including those irrespectively of whether to be printed on a printing medium, such as a paper, by the conventionally known printing process, to be displayed on a display medium, such as a CRT (cathode ray tube), a liquid crystal or an electronic paper, or to be recorded on a storage medium, such as a flexible disk, by technique of an electromagnetic process. Meanwhile, “document” is a general term of texts and drawing, which refers to a printing medium with printed information such as of characters and images, a display medium displaying information such as of characters and images, or a storage medium recording information such as of characters and images. Namely, it means a result of output based on document data.

The information exchange unit 2 serves as a concept input section. This has an input/selector section 20 and a display 21 in order to enable exchange of a target concept TCO, insert information IN, a template TE and customer information CL between the document production assist apparatuses 1 and the designers. The input/selector section 20 is an input interface, e.g. a keyboard, a mouse, a touch panel or a tablet. This allows the designer to input a target concept TCO and to select desired one of insert information IN, template TE and customer information CL out of the candidates of insert information IN, template TE and customer information CL searched out according to the target concept TCO.

The display 21 is a display interface, e.g., a liquid-crystal monitor or a CRT (cathode ray tube) monitor, to display the candidates of insert information IN, template TE and customer information CL.

The processing unit 3 has a control section 30, a search section 31, a processor section 32 and a producer section 33, as constituted by a CPU (central processing unit) and logic circuit for example, in order to modify a target concept TCO inputted at the input/selector section 20 according to a target concept TCO inputted from the information exchange unit 2 and to a concept CO included in the insert information IN and template TE selected by the input/selector section 20.

The control section 30 takes control of operation of the search section 31, processor section 32 and producer section 33, and of operation overall of the document production assist apparatus 1.

The search section 31 has functions as an insert-information search section, a template search section and a user search section. Namely, this is (1) to search a plurality of pieces of insert information IN stored in an insert-information storage section 40 depending upon a target concept TCO inputted through the information exchange unit 2 by the designer, (2) to search a plurality of templates TE stored in a template storage section 41 depending upon the inputted or corrected target concept TCO and (3) to search a plurality of pieces of customer information CL stored in a customer-information storage section 42 depending upon an inputted or corrected target concept TCO.

The processor section 32 can serve as a concept modifying section, to modify the target concept TCO inputted at the input/selector section 20 according to a concept CO contained in the insert information IN, template TE or customer information CL selected by the input/selector section 20.

The producer section 33 can serve as a document data producer section, to create document data DC by use of the insert information IN and template TE searched out by the search section 31.

The storage unit 4 can be made up by a storage medium, such as a hard disk or flexible disk. This has an insert information storage section 40, a template storage section 41, a customer information storage section 42, a program storage section 43 and a concept storage section 44. The insert-information storage section 40 is stored with an insert information database having a plurality of pieces of insert information IN. The template storage section 41 is stored with a template database having a plurality of templates TE. The customer-information storage section 42 can be stored with a customer information database having a plurality of pieces of customer information CL. The program storage section 43 is stored with a program PR allowing the unit 1-3 to perform a process for assisting document production. The concept storage section 44, storing a target concept TCO inputted from the input/selector section 20, is to suitably store a corrected target concept TCO, referred later, i.e., stores the initial target concept TCO (Step S11) and a target concepts TCO (processes S14, S17, S20) in the course of correction. Here, the “plurality” is used to represent the number of one or the greater but not used to represent excluding 1 (this is true for the ensuing).

FIGS. 2, 3 and 4 show the contents of insert information, templates and customer information. The insert information IN is constituted with insert information number, figure or text, and numerical target, purpose and atmosphere, as shown in FIG. 2A. Of a plurality of pieces of insert information IN1-INm (m: desired positive integer) constituting the insert information database IN_DB, insert information IN1, say, includes “FIG. 1” wherein target “20's”=0.8, target “male”=0.7, purpose not defined, atmosphere “chicness”=0.6, and atmosphere “powerfulness”=0.8, as shown in FIG. 2B.

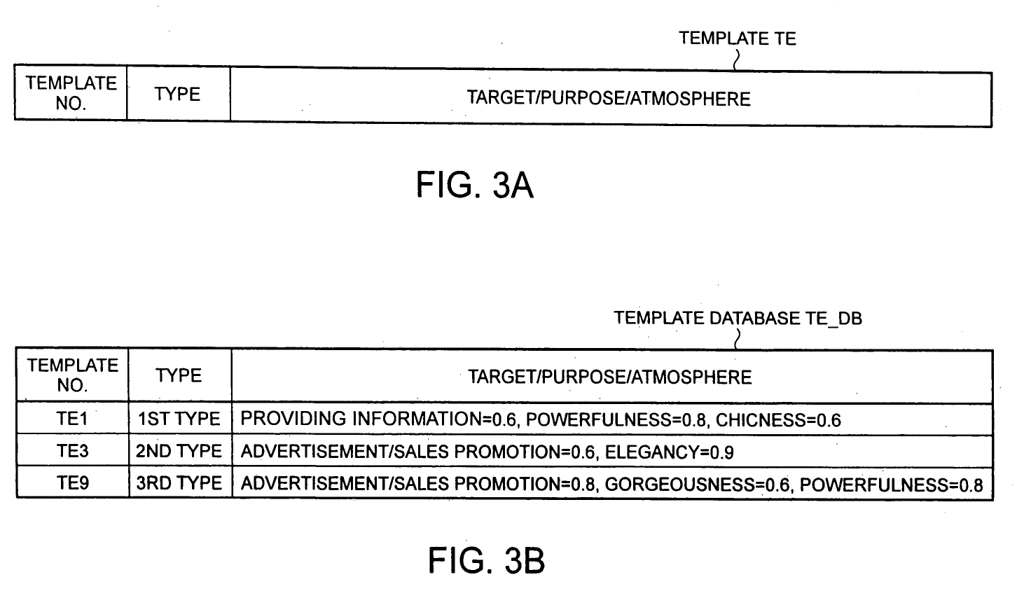

The template TE is constituted with template number, type (information about insert-information arrangement), target, purpose and atmosphere, as shown in FIG. 3A. Of a plurality of templates TE1-TEn (n: desired positive integer) constituting the template database TE_DB, template TE1, say, includes first type, purpose “providing information”=0.6, atmosphere “powerfulness”=0.8 and atmosphere “chicness”=0.6, as shown in FIG. 3B.

The customer information CL is constituted with customer number, customer name, address, target, purpose and atmosphere. Of a plurality of pieces of customer information CL1-CLK (k: desired positive integer) constituting the customer information database CL_DB, customer information CL1, say, includes customer name “Yamada”, address “Yamanashi prefecture”, target “20's”, target “female”, atmosphere “prettiness”=0.3, atmosphere “funniness”=0.3 and atmosphere “elegancy”=0.1.

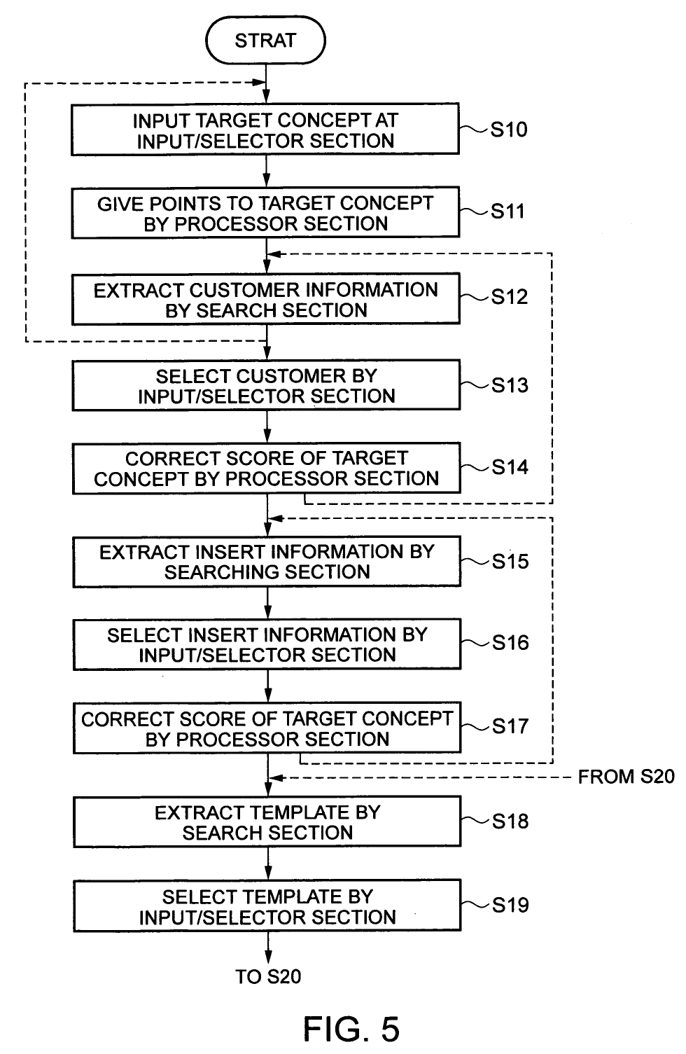

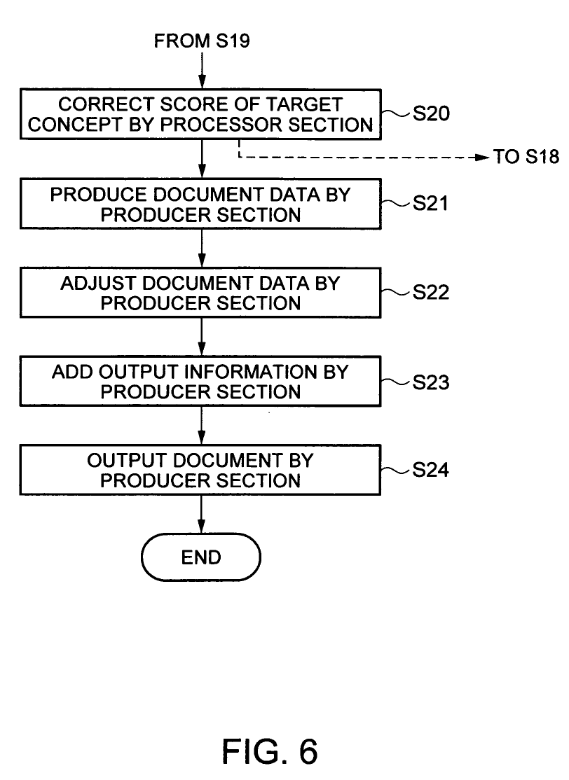

FIGS. 5 and 6 are a flow chart showing an exemplary operation of the document production assist apparatus 1 in this embodiment. The operation of the document production assist apparatus 1 is described along with the flowchart in FIGS. 5 and 6.

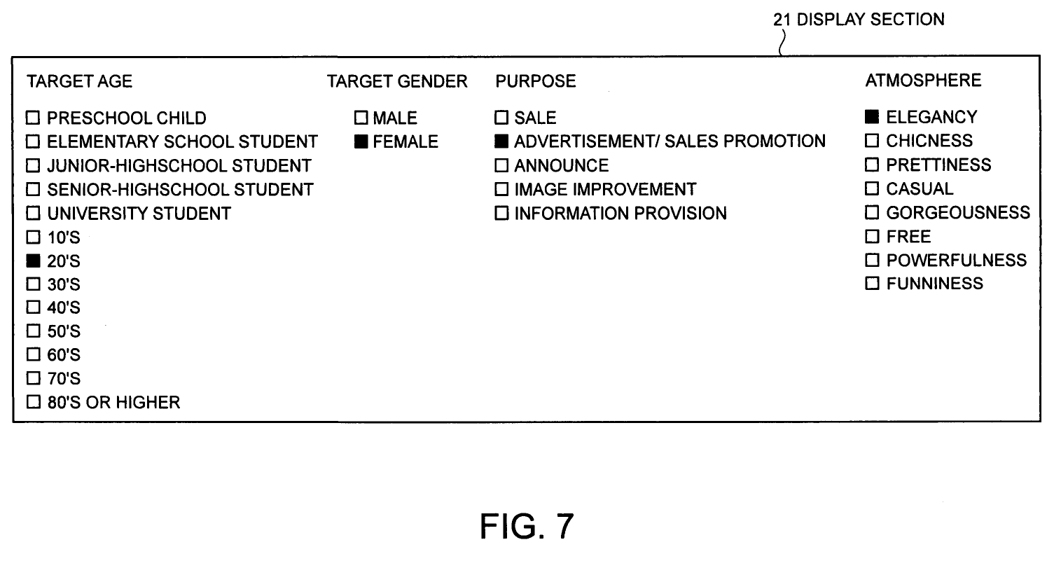

The control section 30 can start up a predetermined program stored in a predetermined domain of a ROM, not shown. According to the program, executed is the Step Shown in the flowchart in FIGS. 5 and 7.

Step S10: The user inputs target, purpose and atmosphere as target concepts TCO through the input/selector section 20. More exactly, the user selects “20's” and “female” as target and gender, “advertisement/sales promotion” as purpose, and “elegancy” as atmosphere from among the items displayed on the display 21 (in FIG. 7, solid squares represent those selected).

Step S11: The processor section 32 gives points as age “20's”=1.0, gender “female”=1.0, purpose “advertisements/sales promotion”=1.0 and atmosphere “elegancy”=1.0, the initial values of the selected target, purpose and atmosphere.

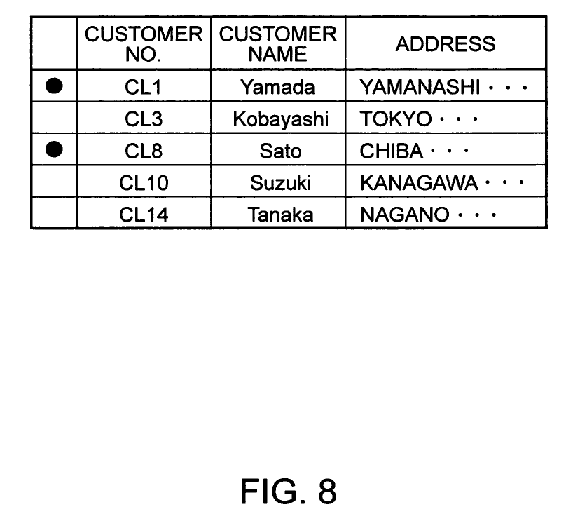

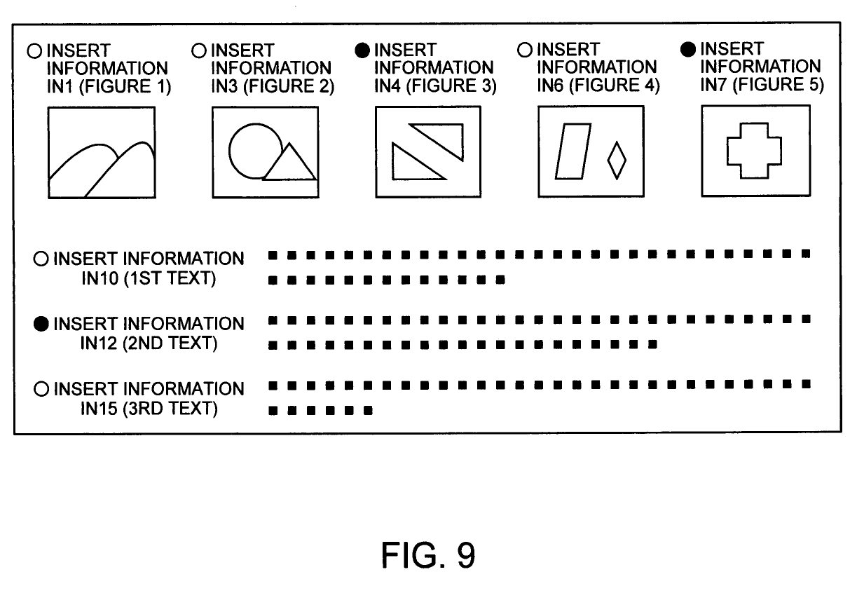

Step S12: The search section 31 searches through the customer-information database CL_DB in the customer-information storage section 42 depending upon the inputted target concept TCO, i.e., upon target age of “20's”, gender of “female”, purpose of “advertisements/sales promotion” and atmosphere of “elegancy”, to thereby extract customer information CL1, CL3, CL8, CL10, CL14 matched with the target concept TCO. The control section 30 displays the five pieces of customer information CL1, CL3, CL8, CL10, CL14 on the display 21, as shown in FIG. 8. When the user decides that executing the subsequent Step S13 is not desirable on the basis of the customer information CL1, CL3, CL8, CL10 and CL14, the control returns to the step S10. In the other case than that, the control proceeds to step S13.

Step S13: The user selects, say, the customer information CL1, CL8 depending upon his/her own decision (in FIG. 8, black circles represent those selected).

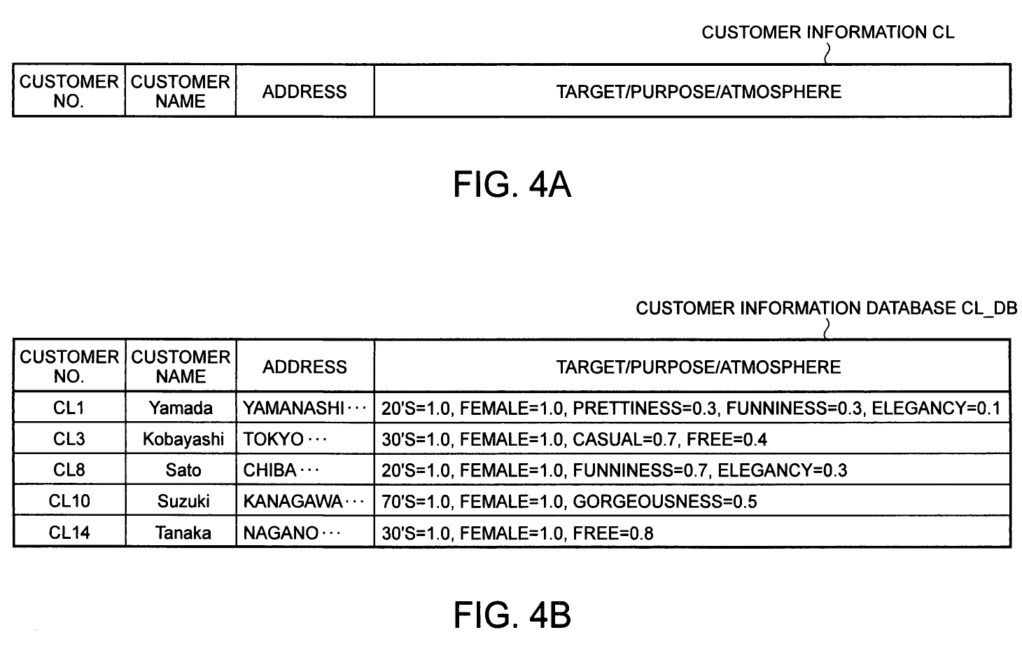

Step S14: The processor section 32 corrects the score of the target concept TCO, i.e. modifies the score of target, purpose and atmosphere by use of the points of target, purpose and atmosphere as to the customer information CL1, CL8 selected in the Step S13. More specifically, the processor section 32 makes again a setting of age “20's”=1.0 because of the fact the age “20's” at Step S11 is 1.0 and the customer information CL1, CL8 selected at the step S13 has age “20's” as shown in FIG. 4B. Likewise, it makes again a setting of gender “female”=1.0 and of purpose “advertisement/sales promotion”=1.0.

Meanwhile, from the fact of atmosphere “elegancy”=1.0 at the step S11 and atmosphere “elegancy”=0.3 in the customer information CL1 selected at the step S13, the value of atmosphere at the step S11 is halved while the numeral of atmosphere at the step S13 is halved, for example. The sum of those halved values is used as an atmosphere post-correction value. Due to this, setting is made again as atmosphere “elegancy”=0.6 (=1.0/2+(0.1+0.3)12/2).

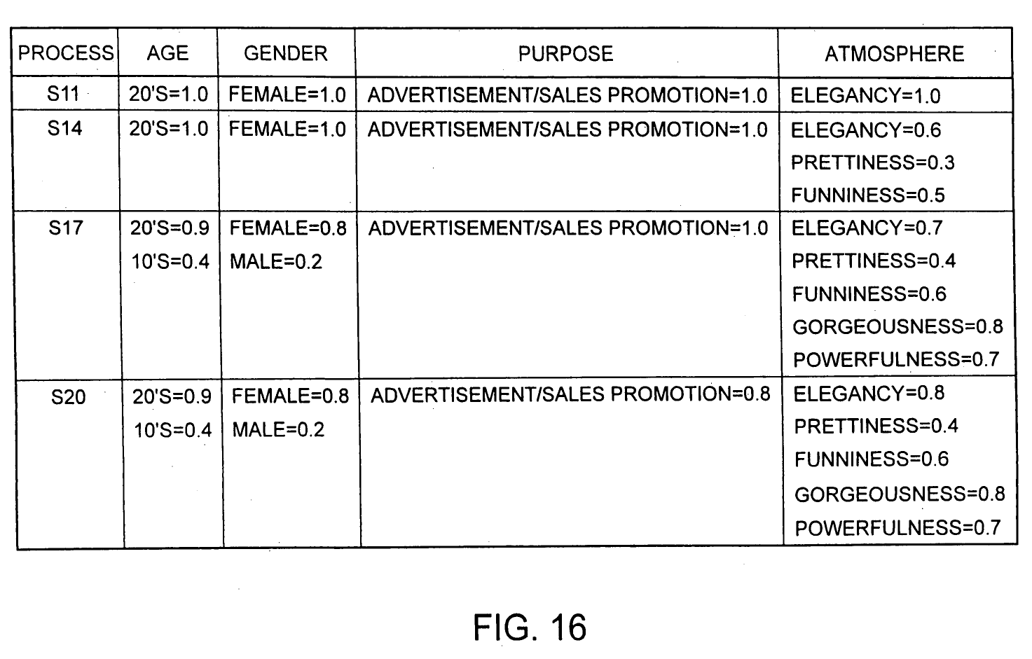

The processor section 32 furthermore makes a setting of atmosphere “prettiness”=0.3 because of atmosphere “prettiness”=0.3 in the customer information CL1. Likewise, because of atmosphere “funniness”=0.3 in the customer information CL1 and atmosphere “funniness”=0.7 in the customer information CL8, setting is made as atmosphere “funniness”=0.5 (=(0.3+0.7)/2). Namely, during the steps of between S11 and S14, the target (age, gender), purpose and atmosphere are corrected in value as shown in FIG. 16.

When again searching through the customer-information database CL-DB depending upon the corrected target, purpose and atmosphere of after the setting, the control returns to the step S12. In the other case than that, the control proceeds to Step S14.

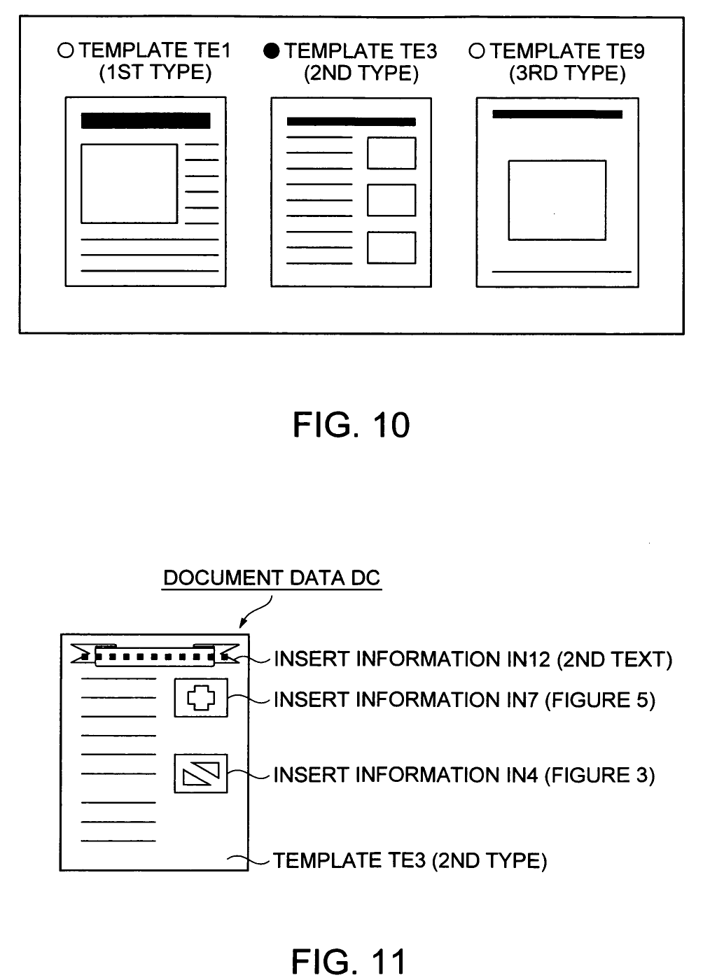

Step S15: The search section 31 searches through the insert-information database IN_DB depending upon the corrected target concept TCO, thereby extracting insert information IN1, IN3, IN4, IN6, IN7, IN10, IN12, IN15 matched to the corrected target concept. The control section 30 displays the extracted insert information IN1, IN3, IN4, IN6, IN7, IN10, IN12, IN15 on the display section 21, as shown in FIG. 9.

Step S16: The user selects insert information IN4 (“FIG. 3”), insert information IN7 (“FIG. 5”) and insert information IN12 (second text) by his/her own intention (in FIG. 9, black circle represents the one selected).

Step S17: The processor section 32 corrects the score of the target concept TCO, i.e. the score of target, purpose and atmosphere at the Step S14 is corrected by using the score of target, purpose and atmosphere of the insert information IN4, IN7, IN12 selected at the Step S16. More specifically, it makes again a setting of age “20's”=0.9 (=1.0/2+(1.0+0.8+0.6)/3/2) because of the age “20's”=1.0 at the step S14 and the age “20's”=1.0, 0.8 and 0.6 in the selected insert information IN4, IN7, IN12. The processor section 32 makes a setting of age “10's”=0.4 as it is because there is no age “10's” in the Step S14 and the age “10's”=0.4 in the insert information IN7.

The processor section 32 makes a similar setting of gender “female”=0.8, gender “male”=0.2, purpose “advertisement/sales promotion”=1.0, atmosphere “elegancy”=0.7, atmosphere “prettiness”=0.4, atmosphere “funniness”=0.6, atmosphere “gorgeousness”=0.8 and atmosphere “powerfulness”=0.7. Namely, during the process of between S14 and S17, the target, purpose and atmosphere is corrected in value as shown in FIG. 16. When again searching the insert-information database IN_DB depending upon the corrected target concept TCO after the above setting, the control returns to the Step S15. In the other case than that, the control proceeds to Step S18.

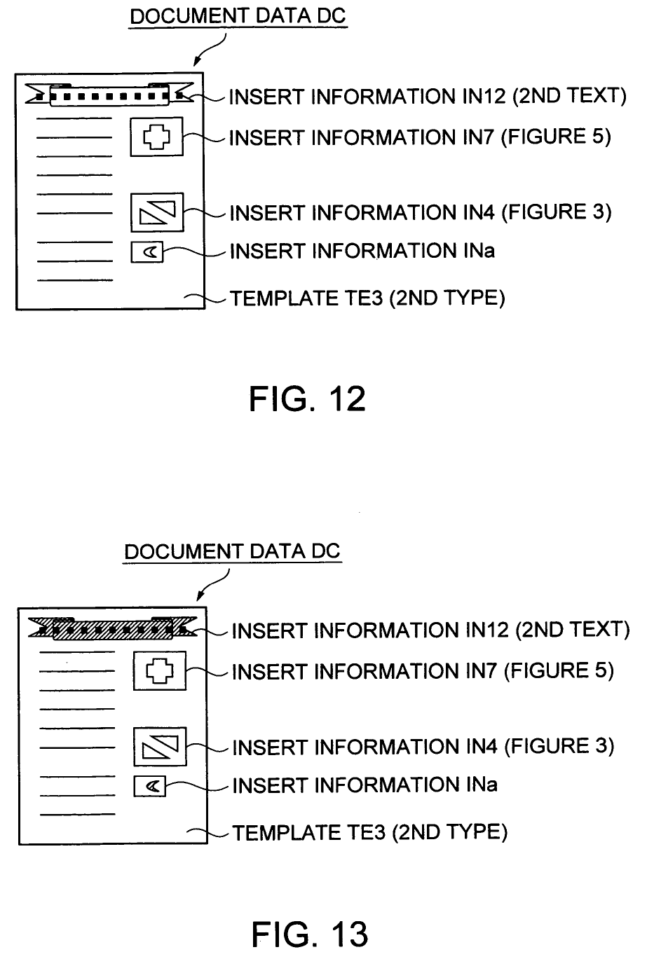

Step S18: The search section 31 searches the template database TE_DB depending upon the corrected target concept TCO, to extract templates TE1, TE3, TE9 matched to the corrected target concept TCO. The control section 30 displays the extracted templates TE1, TE3, TE9 on the display 21, as shown in FIG. 10.

Step S19: The user selects the template TE3 (second type) at the input/selector section 20 by his/her own intention (in FIG. 10, black circles represent those selected).

Step S20: the processor section 32 corrects the step-S17-value of target, purpose and atmosphere by use of the value of target, purpose and atmosphere on the template TE3 selected at the step S19, thereby making a setting of age “20's”=0.9, age “10's”=0.4, gender “female”=0.8, gender “male”=0.2, purpose “advertisement/sales promotion”=0.8, atmosphere “elegancy”=0.8, atmosphere “prettiness”=0.4, atmosphere “funniness”=0.6, atmosphere “gorgeousness”=0.8 and atmosphere “powerfulness”=0.7. The value of target, purpose and atmosphere is corrected at between Step S17 and Step S20, as shown in FIG. 16. After the setting, when searching again the template database TE_DB depending upon the corrected target concept TCO, the control returns to the step S18. In the other case, the control proceeds to step S21.

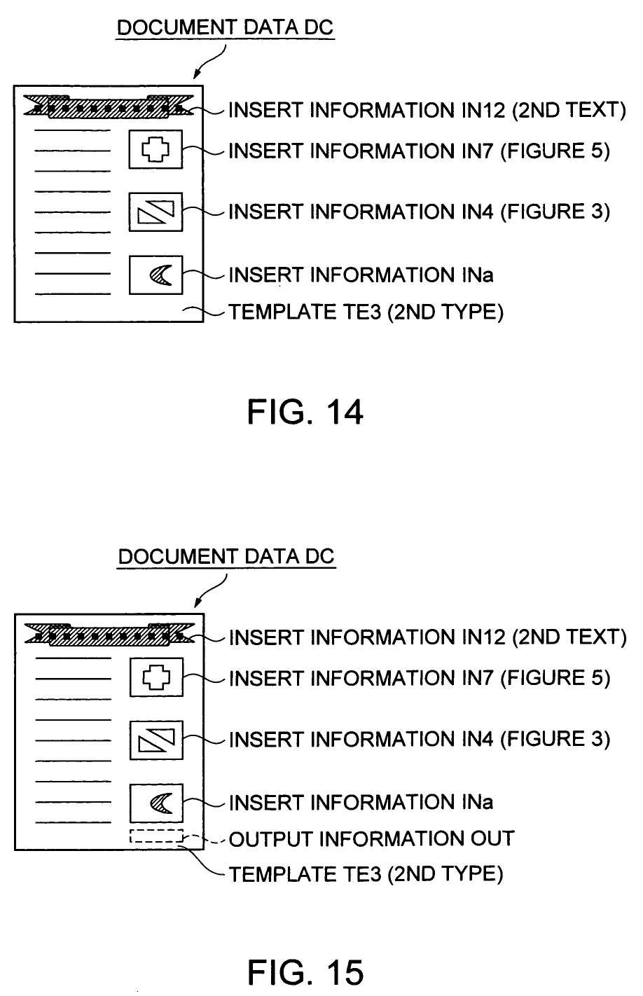

Step S21: the producer section 33 produces document data DC by use of the selected insert information IN4, IN7, IN12 and selected template TE3. Specifically, the producer section 33 (1) arranges the insert information IN4, IN7, IN12 in an insert information IN arrangement frame as shown in FIG. 11, (2) supplements other insert information INa than the insert information IN4, IN7, IN12 by executing the Step S15, S16 by the search section 31 and input/selector section 20 as shown in FIG. 12 when available space (space, margin) in the template TE3 is decided broad, and (3) matches the color tone of a “moon” image represented by the insert information INa to the color tone represented by another piece of insert information IN4 and further places the characters and the background thereof in a complementary color relationship or raises character lightness in order to improve the legibility of the insert information IN12, as shown in FIG. 13.

Step S22: the producer section 33 adjusts the overall of the document data DC. The producer section 33 adjusts the position of the insert information IN4, IN7, INa as shown in FIG. 14 because of importance attached to the symmetry and regularity of document data Dc from a viewpoint of the atmosphere “elegancy”, for example. Otherwise, adjustment is made to avoid such high or low chroma which may lose “elegancy”. Meanwhile, the producer section 33 makes an adjustment to suppress lightness from a viewpoint of the atmosphere “chicness”. The producer section 33 is previously stored with a correspondence between atmosphere and adjustment, e.g., in the form of an intelligence database (not shown).

Step S23: The producer section 33 adds the document data DC with necessary output information OUT as shown in FIG. 15, in order to output document data DC meeting the target concept TCO. Specifically, the producer section 33 instructs a use of glossy ink or a reduction of fixing rate as to the atmosphere “elegancy”, in order to increase the glossiness on the entire document data DC. Meanwhile, concerning the atmosphere “funniness”, instruction is made to paint a fluorescent color in a desired area having the highest chroma, in order to obtain an unexpectedness.

Step S24: the producer section 33 outputs the document data DC onto the output device 5. The output device 5 prints out or so a document according to the output information OUT and document data DC.

As described above, in the document production assist apparatus 1, as shown in FIG. 16, the processor section 32 corrects the value of target concept TCO, i.e., target, purpose and atmosphere, according to the value of target, purpose and atmosphere included in the customer information CL. The search section 31 searches insert information IN depending upon the corrected target concept TCO. Furthermore, the processor section 32 again corrects the target concept TCO depending upon the insert information IN while the search section 31 searches a template TE depending upon the re-corrected target concept TCO. On the other hand, the input/selector section 20 selects the customer information CL, insert information IN and template TE desired by the user from among the searched-out customer information CL, insert information IN and template TE. This makes it possible to reflect a user-desired precise nuance of target concept TCO commonly in selecting customer information CL, insert information In and a template TE. Moreover, the precise nuance can be reflected upon selecting the customer information CL, the insert information IN and a template TE.

By searching and selecting insert information IN and template TE and correcting the target concept TCO without searching customer information CL at all instead of searching and selecting customer information CL, insert information IN and template TE in the order and correcting the target concept TCO, effects can be obtained similarly to the foregoing. Meanwhile, by searching and selecting customer information CL, template TE and insert information IN in this order and correcting the target concept TCO, effects can be obtained similarly to the foregoing.

By arranging the storage unit 4 within a server in a client server system instead of arrangement thereof within the document production assist apparatus 1 and, on the other hand, arranging in a client server a document production assist apparatus not having a storage unit 4, effects can be obtained similarly to the foregoing.

By reading out an order sheet as a paper sheet describing such information as shown in FIGS. 7 to 10 by technique of a scanner on a multi-function printer (MPF) in place of display, input and selection by cooperation of the input/selector section 20 and display 21, effects can be obtained similarly to the foregoing.

In the above exemplary embodiments, the customer information CL was structured including information about customer number, customer name, address, target, purpose and atmosphere. However, it should be understood that this is not limitative, i.e., it can be structured including information about a classification of taste (favorite foods, TV personalities, TV programs, etc.) based on the marketing approach. Here, generally the classification based on the marketing approach refers to a classification called customer segmentation (grouping by basic customer information including gender and age, segmentation by RFM analysis). As for RFM (recency frequency monetary) analysis, report is found detail in the homepage “http://www.atmarkit.cojp/aig/04biz/rfm.html” (as per Dec. 15, 2004).

Meanwhile, the above embodiments provided the document production assist apparatus 1 as an integral apparatus. However, it should be understood that this is not limitative, i.e., the function possessed by the document production assist apparatus 1 can be realized as a function of a network system connecting between a host terminal 100 and a server 200 by a network. Specifically, the following three structures can be proposed.

First described is a first structure.

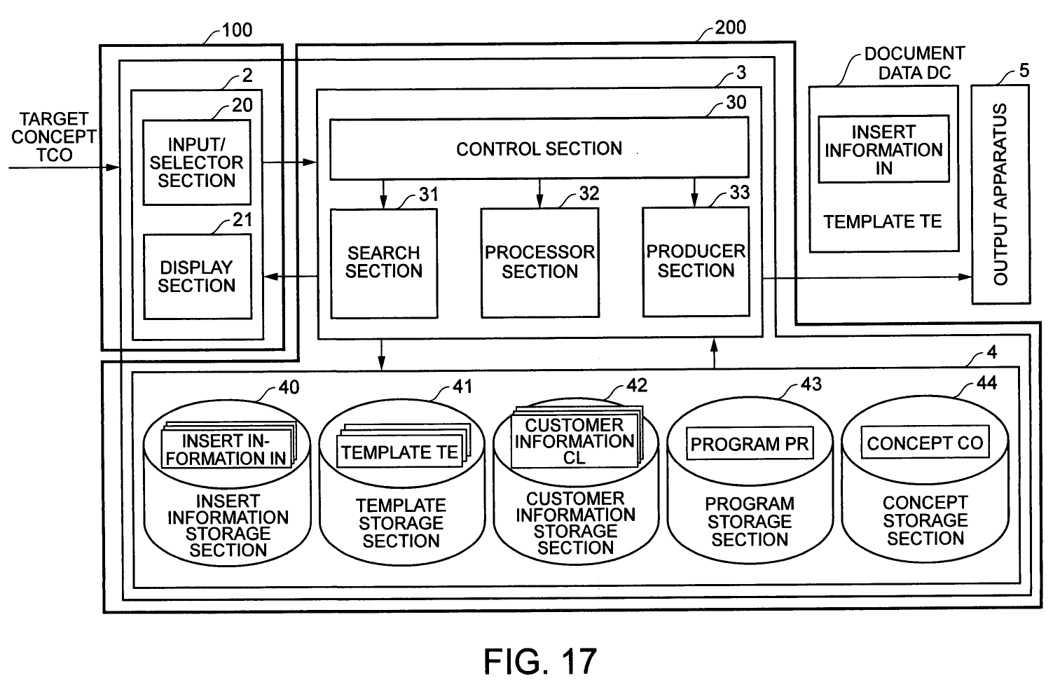

FIG. 17 is an exemplary block diagram showing an arrangement of a network system that the major function is provided on a server 200. A host terminal 100 is configured having a communicating section, not shown, for communication with the server 200 through a network, in addition to the input/selector section 20 and display 21, as shown in FIG. 17. The server 200 is configured having the communication section, not shown, for communication with the host terminal 100 and with the output device 5 through a network, besides a control section 30, a search section 31, a producer section 33, an insert-information storage section 40, a template storage section 41, a customer-information storage section 42, a program storage section 43 and a concept storage section 44. This reduces the process burden on the host terminal 100 thus making it possible to use, as a host terminal 100, a device, such as a cellular phone or a PDA (personal digital assist).

Next described is a second structure.

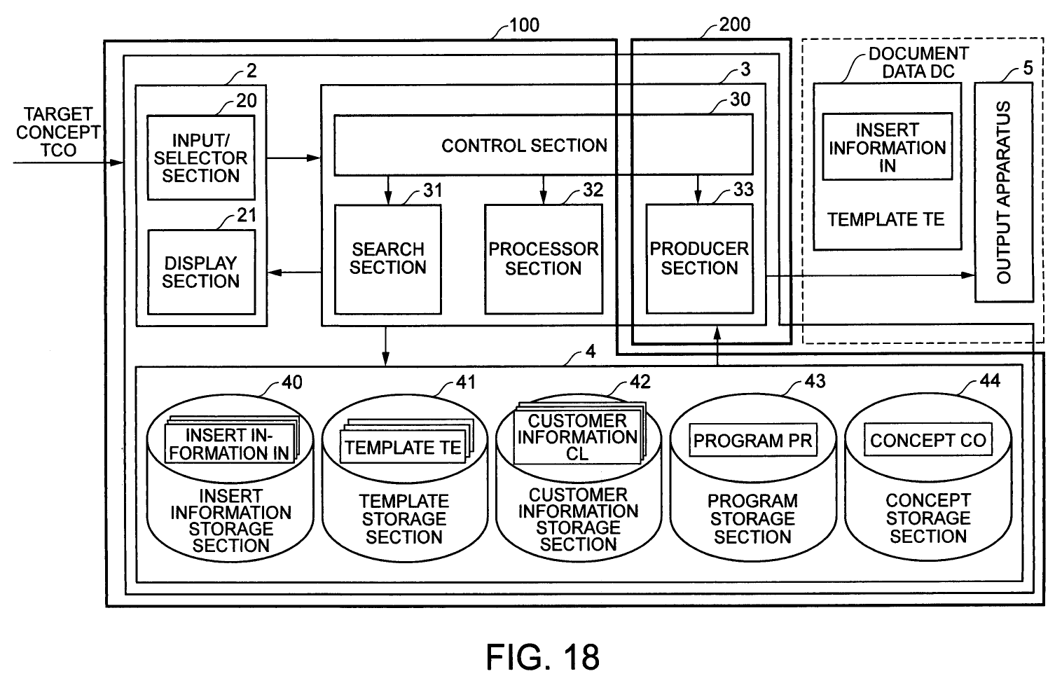

FIG. 18 is an exemplary block diagram showing an arrangement of a network system that the major function is provided on a host terminal 100. The host terminal 100 is configured having a communicating section, not shown, for communication with a server 200 through a network, in addition to an input/selector section 20, display 21, control section 30, search section 31, processor section 32, insert-information storage section 40, template storage section 41, customer-information storage section 42, program storage section 43 and concept storage section 44, as shown in FIG. 18.

The server 200 is configured having the communication section, not shown, for communication with the host terminal 100 and with the output device 5 through a network, besides a control section 30, a producer section 33 and a program storage section 43. With this structure, the host terminal 100 is allowed to have all the data of insert information, template, customer information and concept. The server 200 is to produce document data DC, based upon the insert information, template and concept selected by the host terminal 100.

Due to this, information is included in the host terminal 100, providing a preferred arrangement for a user who does not desired to output unnecessary information. Meanwhile, the server 200 and the output device 5 may be provided as a set form, so that the producer section 33 of the server 200 can have the information about the output device 5. By utilizing the output device 5 based upon such information, the server 200 can carry out a production process on each output device 5 in accordance with the characteristic of the output device 5. The host terminal 100 can obtain a desired output by selecting a server 200 mated with the output device 5 without the need of having the information about the output device 5 characteristic.

Now described is a third structure.

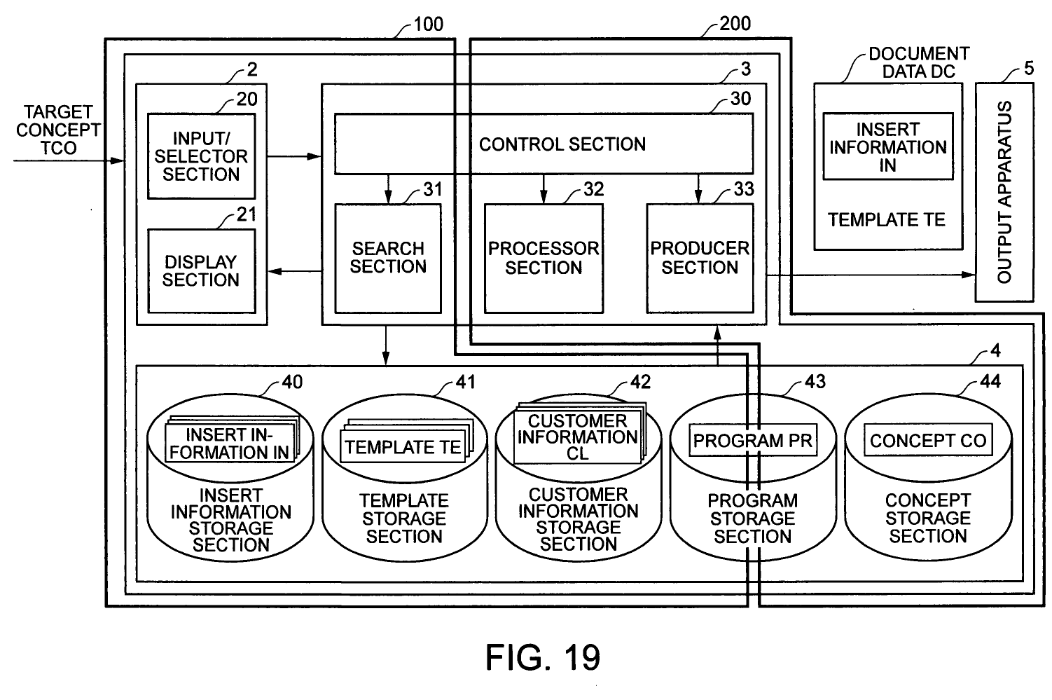

FIG. 19 is an exemplary block diagram showing an arrangement of a network system that the function is provided separately nearly equally on a host terminal 100 and a server 200. The host terminal 100 is configured having a communicating section, not shown, for communication with the server 200 through a network, in addition to the input/selector section 20, display section 21, control section 30, search section 31, insert-information storage section 40, template storage section 41, customer-information storage section 42 and program storage section 43.

The server 200 can be configured having a communicating section, not shown, for communication with the host terminal 100 and output device 5 through a network, in addition to the control section 30, processor section 32, producer section 33, program storage section 43 and concept storage section 44.

This makes it possible to carry out at the host terminal 100 the process of interaction with the user, thus providing a configuration with rapid response to the user. Meanwhile, because the process as to concept is effected at the server 200, it is easy for the user to carry out a complicated intelligent process greater in processing burden and a change onto an upgrade algorithm without user's consciousness thereof. Furthermore, because of no need for the user to store customer information, etc., the structure is preferable also for the user who does not desire to output unnecessary information.

Meanwhile, the above embodiments were configured to correct the score of target concept TCO by use of the points of target, purpose and atmosphere as to customer information CL1, CL2. However, it should be understood that this is not limitative, but the following correction method can be adopted.

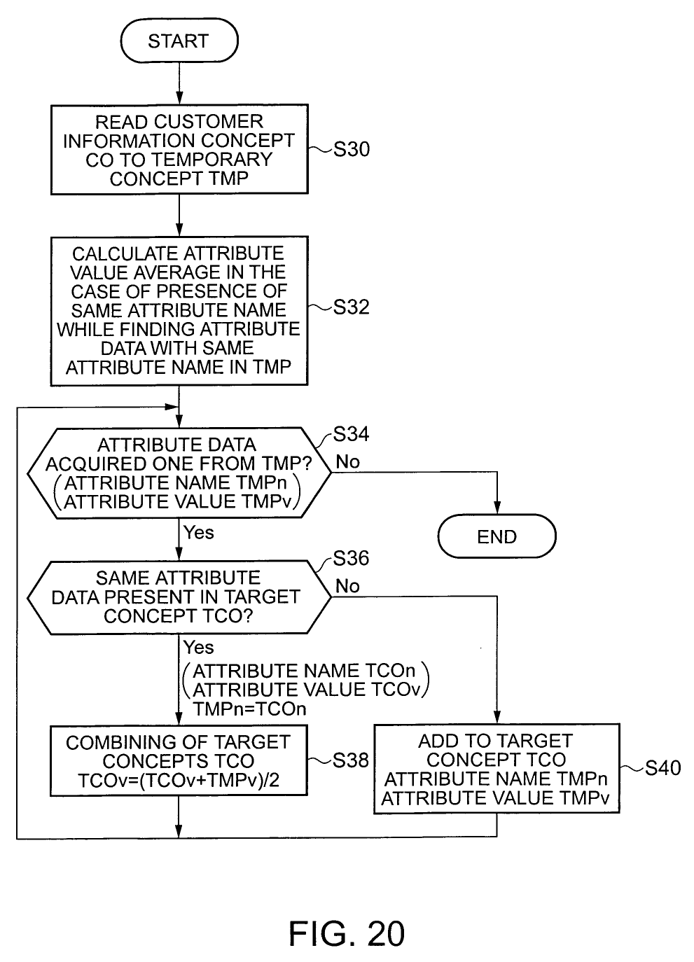

FIG. 20 is a flowchart showing an exemplary target-concept correction process for correcting the target concept TCO depending upon customer information CL.

The target-concept correction process is a process to be executed in place of the Step S14, wherein the control first moves to Step S30 as shown in FIG. 20. In the following process, taken as attribute names are the “20's”, “female”, “prettiness”, etc. in the target, purpose and atmosphere in FIG. 4B and the “20's”, “female”, “advertisement/sales promotion”, etc. in the target, purpose and atmosphere in FIG. 16. The value given corresponding to those are assumed attribute values.

At Step S30, the concept CO included in the selected customer information CL is all read to temporary concept TMP. The control moves to Step S32 where search is made for the same attribute name of attribute data (referring to a set of attribute name TMPn and attribute value TMPv) out of the temporary concept TMP, to calculate an average over the attribute values of the same attribute name of attribute data. Then, the control moves to step S34.

At Step S34, it is decided whether or not attribute data can be obtained one from the temporary concept TMP. When deciding that attribute data is acquired (Yes), the control moves to Step S36.

At Step S36, it is decided whether or not attribute data agreed in attribute name is contained in the target concept TCO, depending upon the acquired attribute data. When deciding that attribute data agreed in attribute name is contained (Yes), the control moves to Step S38 where an average is calculated over the attribute value TCOv fallen under of target concept TCO and the attribute value TMPv of acquired attribute data, and set as a new attribute value TCOv of target concept TCO. Then, the control moves to Step S34.

Meanwhile, when deciding at the Step S36 that attribute data agreed in attribute name is not included in the target concept TCO (No), the control moves to Step S40 where the acquired attribute data is added to the target concept TCO. Then, the control moves to Step S34.

Meanwhile, when deciding at the Step S34 that attribute data cannot be acquired from the temporary concept TMP (No), the processes in series are ended and returned to the former.

An exemplary embodiment is now described. At Step S13, customer information CL1, CL8 is assumably selected. At first, a temporary concept TMP is calculated from the concept CO of the selected customer information. Because the customer information CL1 has 20's=1.0, female=1.0, prettiness=0.3, funniness=0.3 and elegancy=0.1 while the customer information CL8 has 20's=1.0, female=1.0, funniness=0.7 and elegancy=0.3, those are all read as temporary concept TMP. The temporary concept TMP is given as 20's=1.0, female=1.0, prettiness=0.3, funniness=0.3, elegancy=0.1, 20's=1.0, female=1.0, funniness=0.7 and elegancy=0.3.

Then, the average is determined over attribute values while finding the same attribute name of attribute data out of the temporary concept TMP. At first, concerning “20's”, there are two of “20's” whose attribute values are 1.0 and 1.0 thus resulting in (1.0+1.0)/2=1.0 . Next, “female” is given 1.0 similarly. Furthermore, “prettiness” is present only one and kept as it is. As for “funniness”, there are two, i.e. they are 0.3 and 0.7 thus resulting in (0.3+0.7)/2=0.5. Concerning “elegancy”, (0.1+0.3)/2=0.2 results. Namely, temporary concept TMP is given as 20's=1.0, female=1.0, prettiness=0.3, funniness=0.5 and elegancy=0.2.

Then, the target concept is combined while acquiring attribute data one by one from the temporary concept TMP. Because the target concept TCO before processing was as 20's=1.0, female=1.0, advertisement/sales promotion=1.0 and elegancy=1.0, the target concept TCO has combined attributes (attributes whose average was calculated) of “20's”, “female” and elegancy”. The attributes “prettiness” and “funniness” were not present in the target concept TCO and hence added. Meanwhile, “advertisement/sales promotion” did not exist in the temporary concept TMP and hence not processed. As a result, the target concept TCO is given as 20's=1.0, female=1.0, advertisement/sales promotion=1.0, prettiness=0.3, funniness=0.5 and elegancy=0.6. Meanwhile, the embodiments were configured to select customer information CL on the FIG. 8 select screen. However, it should be understood that this is not limitative but customer information CL can be selected by an interface as in the following.

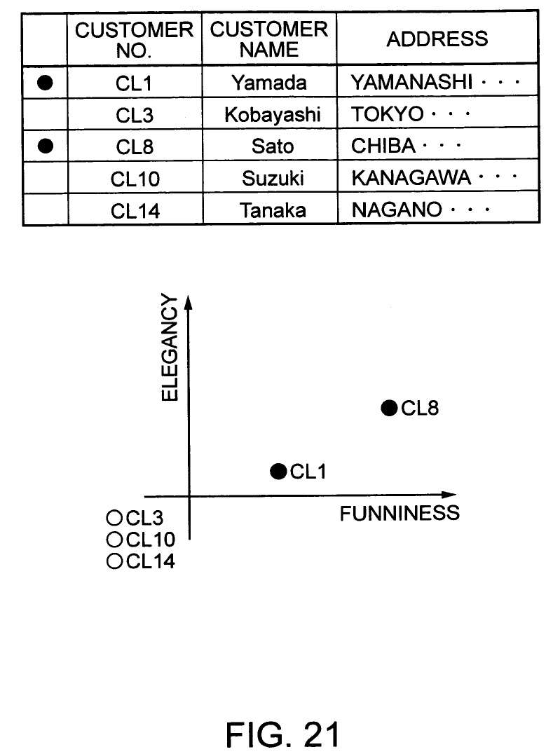

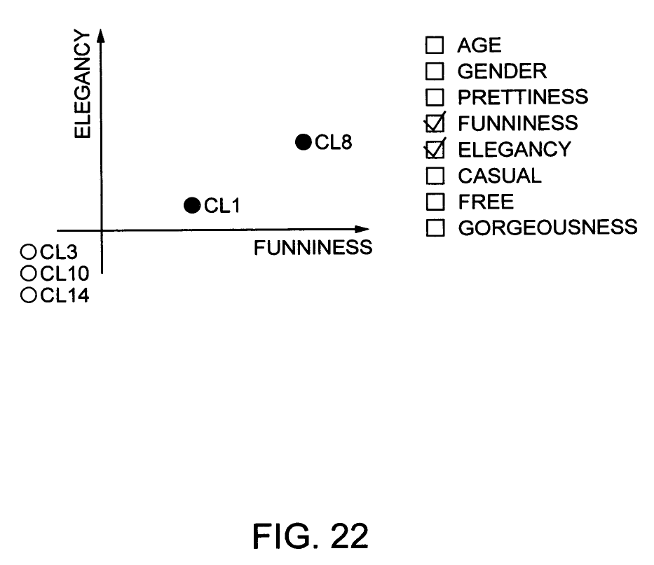

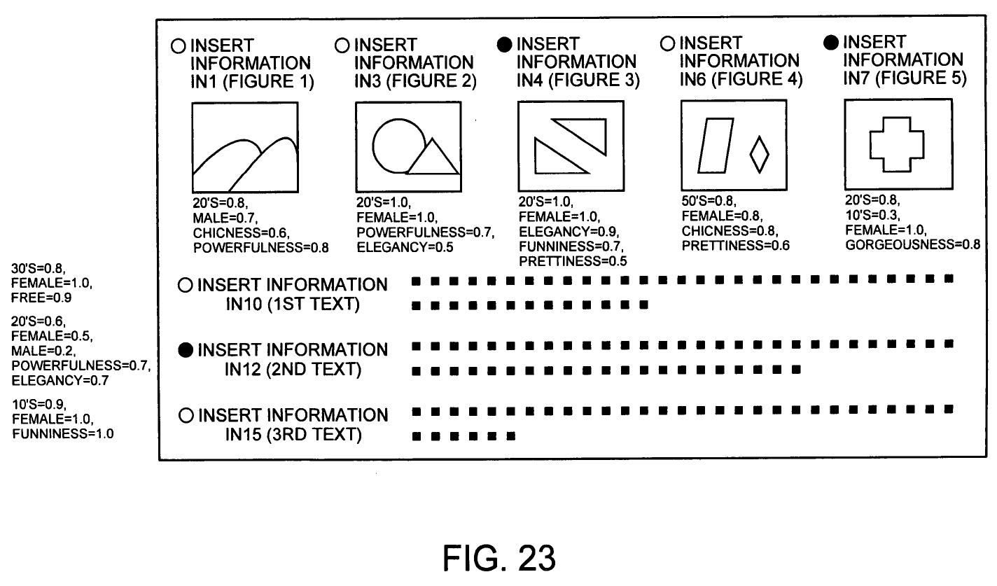

FIGS. 21 and 22 are two-dimensional-space representations of the concepts CO of the customer information CL shown in FIG. 4B, correspondingly to FIG. 8.

As shown in FIGS. 21 and 22, two attributes used the most frequently were selected out of attributes, to arrange customer information CL in a two-dimensional space in accordance with the concept thereof. As for customer information CL3, CL10 and CL14, because there are no attributes of “funniness” and “elegancy”, arrangement is in minus positions.

The user is allowed to select a customer as a target by pointing over a map. By designating an on-map area by such an operation as mouse dragging, the customer of within the area can be selected as a target.

Although the attributes used the most frequently were selected on the axes of the two-dimensional space in FIG. 21, axes may be selected by the user as shown in FIG. 22. Furthermore, representation may be multi-dimensional, i.e., three-dimensional or more, instead of two-dimensional so that navigation is possible through the spaces thereof.

As for age, arrangement is made by data-converting the attributes “20's”, “30's” . . . as “age”=0.2, “age”=0.3, respectively. Likewise, as for gender, “male” is data-converted as “gender”=0.25 while “female” as “gender”=0.75. In concept representation, the attributes “20's”, “30's”, . . . as to age may be converted as “age”=0.2, “age”=0.3 . . . , respectively. Likewise, in gender, “male” may be represented as “gender”=0.25 while “female” as “gender”=0.75.

Meanwhile, the above exemplary embodiments were configured to select insert information on the FIG. 9 select screen. However, it should be understood that this is not limitative but insert information IN can be selected by an interface as in the following.

FIG. 23 is an additional display, to FIG. 9, of the insert information IN concept CO expressed in FIG. 2B. The attributes (sets of attribute names and attribute values) may be listed by texts, as shown in FIG. 23.

Meanwhile, the embodiments were configured to select a template TE on the FIG. 10 select screen. However, it should be understood that this is not limitative but templates TE can be selected by an interface as in the following.

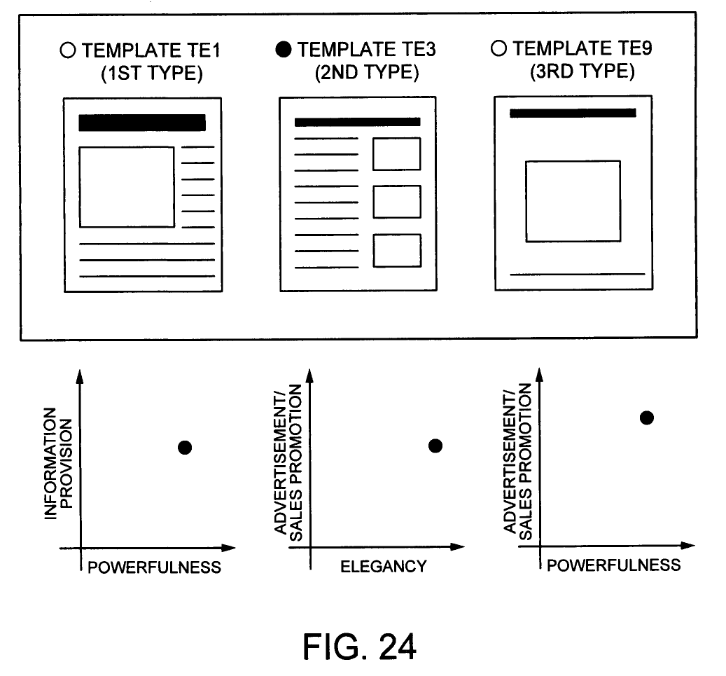

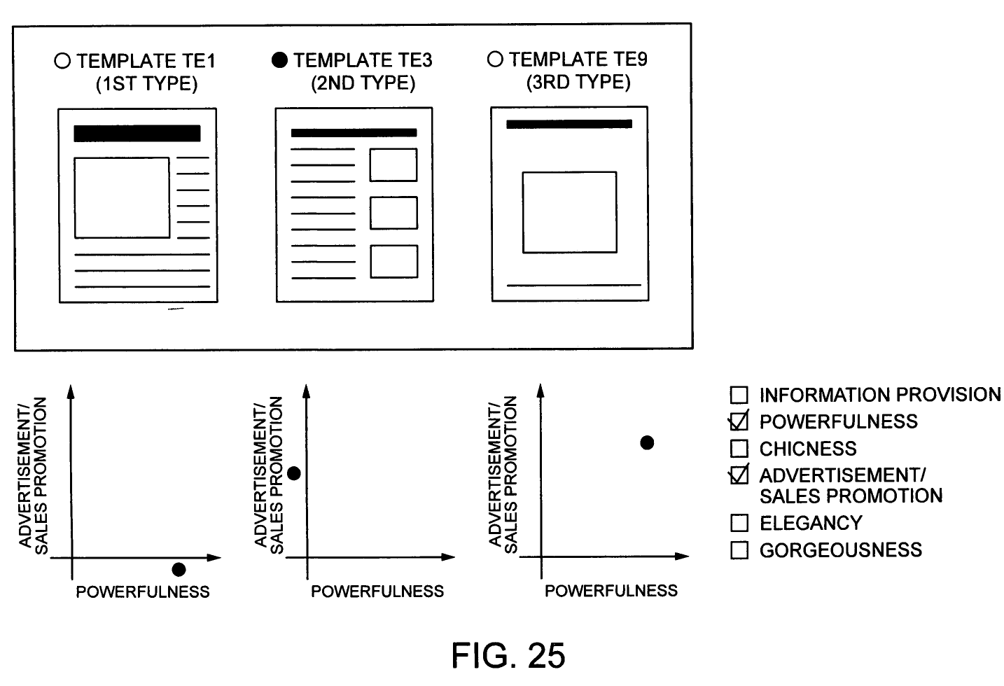

FIGS. 24 and 25 are additional displays, to FIG. 10, of the template TE concept CO to be expressed in FIG. 3B. Although the concept display of customer information CL was shown in the example that selection is possible on a concept-display map as shown in FIGS. 21 and 22, the example of FIGS. 24 and 25 is to merely display information. The manner of map representation is similar to that of customer information CL.

In the example of FIG. 24, there are extracted two greater in attribute value as axes from among the concept CO attributes of each template TE wherein the same attribute lies on the same axis of X or Y.

As in an example of FIG. 25, the input section can be made to select the axes similarly to the FIG. 21 customer information CL. In this case, those not having attributes are arranged in minus positions similarly to the customer information CL.

Meanwhile, the embodiments were explained on the case to executing the control program previously stored in the ROM, in executing the step shown in the flowchart of FIGS. 5 and 20. However, it should be understood that this is not limitative but execution may be by reading a program indicative of the procedure from a storage medium storing same onto a RAM.

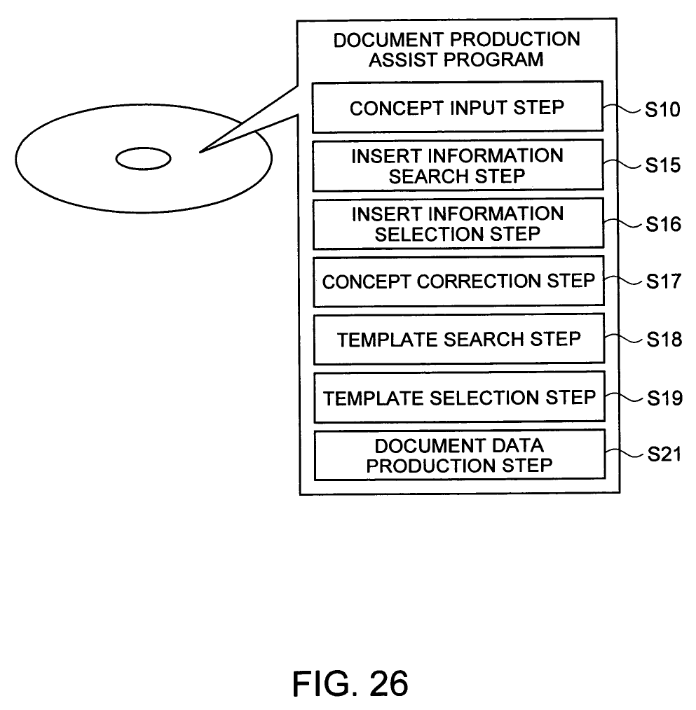

FIG. 26 is a figure showing a storage medium and a data structure thereof.

Here, the storage medium is a semiconductor storage medium such as RAM or ROM, a magnetic storage medium such as FD or HD, an optical-reading-schemed storage medium such as CD, CDV, LD or DVD, or magnetic storage/optical-reading-schemed storage medium such as MO, including any storage medium provided that is a computer-readable storage medium.

Meanwhile, no applications were especially shown of the document production assist apparatus, document production assist program and storage medium, and document production assist method according to the invention. Without limitation, applications are possible to other cases within a range not departing from the gist of the invention. For example, a kiosk terminal can be configured to be set up laterally of a printer.

The search process by the search section 31 is explained as an example to search insert information at the Step S15. In the above embodiment, search and extraction is made as to the insert information in which attribute in agreement exists.

In another embodiment, search is made by calculating a distance between target concept TCO and insert information concept, to extract those a predetermined number in the closer-distance order. As shown in FIG. 16, in insert-information search at the Step S15, the target concept TCO has “20's”=1.0, “female”=1.0, “advertisement/sales promotion”=1.0, “elegancy”=0.6, “prettiness”=0.3 and “funniness”=0.5. The distance between insert information and target concept TCO is determined as a sum of absolute value differences on each attribute. Concerning the attribute “20's”, the distance as to “20's” is 0.2 because target concept TCO is 1.0 and insert information IN1 is 0.8. In the absence of attribute, calculation is with zero. For example, although insert information IN1 has “male”=0.7, there is no attribute “male” in the target concept TCO. Accordingly, the distance as to “male” is given 0.7. Determining a sum of those, the distance between target concept TCO and insert information IN1 is 0.2 (20's)+1.0 (female)+1.0 (advertisement/sales promotion)+0.6 (elegancy)+0.3 (prettiness)+0.5 (funniness)+0.7 (male)+0.6 (chicness)+0.8 (powerfulness)=5.7. For all the pieces of insert information IN stored in the insert-information storage section, the distance to target concept TCO is calculated, to extract a predetermined number of insert information higher in ranking.

While this invention has been described in conjunction with the specific embodiments thereof, it is evident that many alternatives, modifications, and variations will be apparent to those skilled in the art. Accordingly, preferred embodiments of the invention as set forth herein are intended to be illustrative, not limiting. There are changes that may be made without departing from the spirit and scope of the invention.

1. A document production assist apparatus, comprising:
a concept input section that inputs a target concept for deciding insert information and a template that are to be included in document data, the insert information defining a content of the document data and the template defining a form of the document data;
an insert information storage section that stores a plurality of pieces of insert information having concepts;
a template storage section that stores a plurality of template having concepts;
an insert information search section that searches for candidates of insert information corresponding to the target concept inputted at the concept input section through the insert information storage section;
an insert information selecting section that selects insert information intended to be included in the document data out of the candidates of insert information;
a concept correcting section that corrects the target concept inputted at the concept input section depending upon the concept of insert information selected;
a template search section that searches for candidates of template corresponding to the target concept corrected through the template storage section;
a template selecting section that selects a template intended to be included in the document data out of the candidates of template; and
a document data producer section that produces the document data from the selected insert information and the selected template.

2. A document production assist apparatus according to claim 1, further including:
a user information storage section that stores information about a plurality of users;
a user search section that searches for candidates of users corresponding to the target concept through the user information storage section; and
a user selecting section that selects a user who intends to utilize the document data out of the candidates of user;
the concept correcting section that corrects the target concept depending upon the selected information about the user.

3. A document production assist apparatus according to claim 1, the document data producer section adding the document data with output information for outputting the document data meeting the target concept.

4. A document production assist apparatus, comprising:
a concept input section that inputs a target concept for deciding first information defining one of content and form of document data and second information defining the one or the other that are to be included in the document data;
a first information storage section that stores a plurality of pieces of first information having concepts;
a second information storage section that stores a plurality of pieces of second information having concepts;
a first search section that searches for candidates of first information corresponding to the target concept inputted at the concept input section through the first information storage section;
a first information selecting section that selects first information intended to be included in the document data out of the candidates of first information;
a concept correcting section that corrects the target concept inputted at the concept input section depending upon the selected concept of first information;
a second information search section that searches for candidates of second information corresponding to the corrected target concept through the second information storage section;
a second information selecting section that selects second information intended to be included in the document data out of the candidates of second information; and
a document data producer section that produces the document data from the first information selected and the second information selected.

5. A document production assist program that causes a computer, having a concept input section, an insert information search section, an insert information selecting section, a concept correcting section, a template search section, a template selecting section and a document data producer section that are to cooperatively assist in producing document data, to assist in producing the document data having insert information defining a content of document data and the template defining a form of the document data, the program comprising:
inputting a target concept that decides the insert information and the template to the concept input section;
causing the insert information search section to search for candidates of insert information corresponding to the target concept;
causing the insert information selecting section to select insert information intended to be included in the document data out of the candidates of insert information;
causing the concept correcting section to correct the target concept depending upon the selected concept of insert information;
causing the template search section to search for candidates of template corresponding to the corrected target concept;
causing the template selecting section to select a template intended to be included in the document data out of the candidates of template; and
causing the document data producer section to produce the document data from the selected insert information and the selected template.

6. A document production assist method, comprising:
inputting a target concept that decides insert information and a template that are to be included in document data, the insert information being to define a content of the document data and the template being to define a form of the document data;
searching for candidates of insert information corresponding to the target concept;
selecting insert information intended to be included in the document data out of the candidates of insert information;
correcting the target concept inputted in the input step depending upon the selected concept of insert information;
searching for candidates of template corresponding to the corrected target concept;
selecting a template intended to be included in the document data out of the candidates of template; and
producing the document data from the selected insert information and the selected template.

7. A document production assist apparatus, comprising:
a concept input section that allows to input a target concept that extracts insert information and a template;
an insert information storage section that stores the insert information including concepts;
a template storage section that stores the template including concepts;
an insert information search section that searches out candidates of insert information corresponding to the target concept inputted at the concept input section from the insert information storage section;
an insert information selecting section that selects insert information intended to be included in document data out of the extracted candidates of insert information;
a concept correcting section that corrects the target concept inputted at the concept input section depending upon the selected concept of insert information;
a template search section that searches out candidates of template corresponding to the corrected target concept from the template storage section;
a template selecting section that selects a template intended to be included in the document data out of the extracted candidates of template; and
a document data producer section that produces the document data from the selected insert information and the selected template.

8. A document production assist apparatus according to claim 7, further comprising:
a user information storage section that stores information about user;
a user search section that searches out candidates of users corresponding to the target concept from the user information storage section;
a user selecting section that selects a user who intends to utilize the document data out of the candidates of user; and
the concept correcting section correcting the target concept depending upon the selected information about user.

9. A document production assist apparatus according to claim 7, the document data producer section adding the document data with output information corresponding to the target concept.

10. A document production assist apparatus, comprising:
a concept input section that receives an input of a target concept that extracts first information as one of insert information and a template and second information as the other of the insert information and the template;
a first information storage section that stores the first information including concepts;
a second information storage section that stores the second information including concepts;
a first information search section that searches out candidates of first information corresponding to the target concept inputted at the concept input section from the first information storage section;
a first information selecting section that selects first information intended to be included in document data out of the extracted candidates of first information;
a concept correcting section that corrects the target concept inputted at the concept input section depending upon the selected concept of first information;
a second information search section that searches out candidates of second information corresponding to the corrected target concept from the second information storage section;
a second information selecting section that selects second information intended to be included in the document data out of the extracted candidates of second information; and
a document data producer section that produces the document data from the selected first information and the selected second information.

11. A document production assist program including a program that causes a computer to execute a process, comprising:
inputting a target concept that extracts insert information and a template;
searching out candidates of insert information corresponding to the target concept inputted in the concept input step from the insert information storage section storing the insert information including concepts;
selecting insert information intended to be included in document data out of the extracted candidates of insert information;
correcting the target concept inputted at the concept input section depending upon the selected concept of insert information;
searching out candidates of template corresponding to the corrected target concept from the template storage section storing the template including concepts;
selecting a template intended to be included in the document data, out of the extracted candidates of template; and
producing the document data from the selected insert information and the selected template.

12. A document production assist program including a program that causes a computer to execute a process, comprising:
inputting a target concept that extracts first information as one of insert information and a template and second information as the other of the insert information and the template;
searching out candidates of first information corresponding to the target concept inputted in the concept input step from first information storage section storing the first information including concepts;
selecting first information intended to be included in document data out of the extracted candidates of first information;
correcting the target concept inputted in the concept input step depending upon the selected concept of first information;
searching candidates of second information corresponding to the corrected target concept from second information storage section storing the second information including concepts;
selecting second information intended to be included in the document data out of the extracted candidates of second information; and
producing the document data from the selected first information and the selected second information.

13. A computer-readable storage medium storing a program that causes a computer to execute a process, comprising:
inputting a target concept that extracts insert information and a template;
searching out candidates of insert information corresponding to the target concept inputted in the concept input step from the insert information storage section storing the insert information including concepts;
selecting insert information intended to be included in document data out of the extracted candidates of insert information;
correcting the target concept inputted at the concept input section depending upon the selected concept of insert information;
searching out candidates of template corresponding to the corrected target concept from the template storage section storing the template including concepts;
selecting a template intended to be included in the document data out of the extracted candidates of template; and
producing the document data from the selected insert information and the selected template.

14. A computer-readable storage medium storing a program that causes a computer to execute a process, comprising:
inputting a target concept that extracts first information as one of insert information and a template and second information as the other of the insert information and the template;
searching out candidates of first information corresponding to the target concept inputted in the concept input step from a first information storage section storing the first information including concepts;
selecting first information intended to be included in document data out of the extracted candidates of first information;
correcting the target concept inputted in the concept input step depending upon the selected concept of first information;
searching out candidates of second information corresponding to the corrected target concept from a second information storage section storing the second information including concepts;
selecting second information intended to be included in the document data out of the extracted candidates of second information; and
a document data producing step of producing the document data from the selected first information and the selected second information.

15. A document production assist method, comprising:
inputting a target concept that extracts insert information and a template;
searching out candidates of insert information corresponding to the target concept inputted in the concept input step from the insert information storage section storing the insert information including concepts;
selecting insert information intended to be included in document data out of the extracted candidates of insert information;
correcting the target concept inputted in the concept input step depending upon the selected concept of insert information;
searching out candidates of template corresponding to the corrected target concept from the template storage section storing the template including concepts;
selecting a template intended to be included in the document data out of the extracted candidates of template; and
producing the document data from the selected insert information and the selected template.

16. A document production assist method, comprising:
a concept input step that an input section inputs a target concept that extracts insert information and a template;
an insert information search step that a search section searches out candidates of insert information corresponding to the target concept inputted in the concept input step from the insert information storage section storing the insert information including concepts;
an insert information selecting step that a selecting section selects insert information intended to be included in document data out of the extracted candidates of insert information;
a concept correcting step that a processor section corrects the target concept inputted in the concept input step depending upon the selected concept of insert information;
a template search step that the search section searches out candidates of template corresponding to the corrected target concept from the template storage section storing the template including concepts;
a template selecting step that the selecting section selects a template intended to be included in the document data out of the extracted candidates of template; and
a document data producing step that a producer section produces the document data from the selected insert information and the selected template.

17. A document production assist method, comprising:
a concept input step that inputs a target concept that extracts first information as one of insert information and a template and second information as the other of the insert information and the template;
a first information search step that searches out candidates of first information corresponding to the target concept inputted in the concept input step from a first information storage section storing the first information including concepts;
a first information selecting step that selects first information intended to be included in document data out of the extracted candidates of first information;
a concept correcting step that corrects the target concept inputted in the concept input step depending upon the selected concept of first information;
a second information search step that searches out candidates of second information corresponding to the corrected target concept from second information storage section storing the second information including concepts;
a second information selecting step that selects second information intended to be included in the document data out of the extracted candidates of second information; and
a document data producing step that produces the document data from the selected first information and the selected second information.

18. A document production assist method, comprising:
a concept input step that an input section inputs a target concept that extracts first information as one of insert information and a template and second information as the other of the insert information and the template;
a first information search step that a search section searches out candidates of first information corresponding to the target concept inputted in the concept input step from a first information storage section storing the first information including concepts;
a first information selecting step that a selecting section selects first information intended to be included in document data out of the extracted candidates of first information;
a concept correcting step that a processor section corrects the target concept inputted in the concept input step depending upon the selected concept of first information;
a second information search step that the search section searches out candidates of second information corresponding to the corrected target concept from second information storage section storing the second information including concepts;
a second information selecting step that the selecting section selects second information to be included in the document data out of the extracted candidates of second information; and
a document data producing step that a producer section produces the document data from the selected first information and the selected second information.
